(19) United States
(12) Patent Application Publication
(10) Pub. No.: US 2024/0400288 A1
(43) Pub. Date: Dec. 5, 2024

(54) INSULATING CONTAINER

(71) Applicant: RTIC Outdoors, LLC, Houston, TX (US)

(72) Inventors: Steve Whitworth, Houston, TX (US); David Findlay, Houston, TX (US); Ryan Wills, Carrollton, TX (US)

(21) Appl. No.: 18/204,028

(22) Filed: May 31, 2023

(51) Int. Cl. B65D 81/38; B65D 25/28; B65D 25/42; B65D 25/56; B65D 43/16; B65D 45/22; B65D 47/20; B65D 51/24

(52) U.S. Cl. CPC B65D 81/3813; B65D 25/2867; B65D 25/42; B65D 25/56; B65D 43/165; B65D 45/22; B65D 47/20; B65D 51/245; B65D 2251/1058; B65D 2525/289; B65D 2543/00194

(57) ABSTRACT

Disclosed herein are systems and methods for a container having a base that includes an outer wall, an insulation layer, and an inner wall. The container further includes a movable lid connected to the base, and a plurality of spigots are coupled to a front wall of the base at a second end thereof. The second end is opposite the first end, the front wall is opposite a rear wall, and the front wall is connected to the rear wall by a pair of side walls. A plurality of flow channels are formed in the inner wall of the base, and the plurality of spigots are fluidly coupled to the plurality of flow channels.

### BACKGROUND OF THE DISCLOSURE

### 1. Field of the Disclosure

The present disclosure relates to non-rigid and rigid portable containers and methods of manufacturing and use therefore, including a container for dispensing a beverage, which is also referred to as a cooler.

### 2. Description of the Background of the Disclosure

Coolers can be useful to transport, physically protect, and thermally insulate various items in solid and liquid form. For example, beverage containers, including aluminum cans or glass bottles for beer, seltzers, non-alcoholic beverages and the like, are often stored within a rigid or non-rigid portable cooler in large quantities and transported to a particular location for consumption. In addition, fluid beverages, e.g., water or sports drinks, are often stored directly within a cooler. Fluid beverages are also often enjoyed at cold temperatures and, thus, it is desired for coolers to thermally insulate the fluid beverages during transport and/or during storage on-site. Further, coolers that can receive large quantities of fluid beverages and provide systems for dispensing such beverages are desired. In particular, it is desired that coolers have dispensing systems that allow fluids to be dispensed from the cooler quickly and efficiently.

### SUMMARY

Various aspects are described in connection with illustrative implementation of a container disclosed herein.

In some aspects, a container includes a base that includes an outer wall, an insulation layer, and an inner wall. The container further includes a movable lid connected to the base, and a plurality of spigots are coupled to a front wall of the base at a second end thereof. The second end is opposite the first end, the front wall is opposite a rear wall, and the front wall is connected to the rear wall by a pair of side walls. The container further includes a plurality of flow channels formed in the inner wall of the base, and the plurality of spigots are fluidly coupled to the plurality of flow channels. In some embodiments, each spigot in the plurality of spigots includes a housing that is that is coupled to the inner wall of the base and that defines a cavity therein. In some embodiments, each spigot further includes spigot body secured within the cavity and including a spout, a spout bearing, and a press tab. In some embodiments, each spigot further includes a gasket coupled to the housing and the spigot body within the cavity, and each spigot defines a flow channel aperture therethrough that is coupled to a channel in the plurality of flow channels.

In some embodiments, the spigot is configured to be rotated between a closed position and an open position. In some embodiments, a spring is coupled to the spigot body within the cavity and is configured to rotate the spigot in a first direction towards the closed position. In some embodiments, pressing the press tab rotates the spigot in a second direction toward the open position, and a locking bar is coupled to the housing and is configured to selectively engage with the press tab to lock the spigot in the open position. In some embodiments, the outer wall defines a y-axis that extends between the first end and the second end of the container, and the container further includes a plurality of lid fasteners coupled to the lid. In some embodiments, the plurality of spigots are horizontally aligned with the plurality of lid fasteners with respect to the y-axis.

According to another aspect of the disclosure, a container includes a base that includes an outer wall, an insulation layer, and an inner wall. The container further includes a lid having a top portion, an insulation portion, and a bottom portion, and the lid is coupled to the base at a first end thereof. The container further includes a valve disposed within the lid that is configured to be rotated between a first position and a second position, and the valve is spaced apart from a flow channel formed along the inner wall of the base at a second end that is opposite the first end. When the valve is in the first position, an outlet of the valve is in communication with an internal volume of the container. When the valve is in the second position, the outlet of the valve is not in fluid communication with the internal volume of the container. In some embodiments, the valve is received within a valve aperture that extends longitudinally through each of the top portion, the bottom portion, and the insulation portion of the lid.

In some embodiments, the valve includes a hollow valve body, legs extending downward from the hollow valve body, and a rectangular tab extending upward from the hollow valve body. In some embodiments, an airflow path between the internal volume of the container and the outlet of the valve is defined through the hollow valve body when the valve is in the first position, and the top portion of the lid defines a recessed portion that surrounds the valve aperture and includes a first marker disposed thereon. In some embodiments, the valve includes a second marker disposed thereon that indicates a rotational position of the valve relative to the first marker disposed within the recessed portion of the top portion of the lid. In some embodiments, the flow channel includes a plurality of flow channels and the container includes a plurality of spigots fluidly coupled to the plurality of flow channels.

According to another aspect of the disclosure, a container includes a base that includes an outer wall, an insulation layer, and an inner wall. The container further includes a lid coupled to the base at a first end thereof and a fill level component coupled to the outer wall. The container further includes a central aperture formed through the outer wall and the insulation layer and a central window disposed in the inner wall. The fill level component, the central aperture, and the central window are aligned with one another such that at least one of an internal volume of the container or contents therein is visible through the fill level component. In some embodiments, the fill level component includes gradient lines disposed thereon corresponding to content levels of the internal volume of the container. In some embodiments, the central window is integrally formed with the inner wall, and the fill level component includes a plurality of fastening posts extending around a periphery thereof. In some embodiments, the central aperture includes a plurality of fastening tabs around a periphery of the central aperture. In some embodiments, the fill level component is translucent or transparent, and the central window is translucent or transparent.

Various alternative implementations of the foregoing aspects are disclosed. The foregoing various aspects may be combined in any manner without limitation. The foregoing and other aspects and advantages of the disclosure will appear from the following description. In the description, reference is made to the accompanying drawings, which form a part hereof, and in which there is shown by way of illustration a preferred configuration of the disclosure. Such configuration does not necessarily represent the full scope of the disclosure, however, and reference is made therefore to the claims herein for interpreting the scope of the disclosure.

### BRIEF DESCRIPTION OF THE DRAWINGS

The present disclosure will be better understood and features, aspects, and advantages other than those set forth above will become apparent when consideration is given to the following detailed description thereof. Such detailed description makes reference to the following drawings.

FIG. 1 is a front, top, and right side isometric view of a first embodiment of a container, according to an embodiment of the present disclosure;

FIG. 2 is a right-side elevational view of the container of FIG. 1;

FIG. 3 is a rear elevational view of the container of FIG. 1;

FIG. 4 is top plan view of the container of FIG. 1;

FIG. 5 is a bottom plan view of the container of FIG. 1;

FIG. 6 is a front elevational view of the container of FIG. 1;

FIG. 7 is a front, top, and right side isometric view of a second embodiment of a container, according to an embodiment of the present disclosure;

FIG. 8 is a right-side elevational view of the container of FIG. 7;

FIG. 9 is a rear elevational view of the container of FIG. 7;

FIG. 10 is a is a front elevational view of the container of FIG. 7;

FIG. 11 is an exploded view of the container of FIG. 1, which is shown with a break line to indicate the container may vary in height;

FIG. 12 is a top plan view of the container of FIG. 1 with a lid in an open configuration, according to an embodiment of the present disclosure.

FIG. 13 is an exploded view of a lid of the container of FIG. 11;

FIG. 14 is a partial cross-sectional view of a valve disposed in a lid of the container of FIG. 1 taken through line 14-14 of FIG. 2;

FIG. 15 is an exploded view of a spigot assembly of the container of FIG. 11;

FIG. 16 is a partial cross-sectional view of the container of FIG. 1 taken through line 16-16 of FIG. 6. with a spigot assembly in a closed configuration;

FIG. 17 is a partial cross-sectional view of the container of FIG. 1 taken through line 16-16 of FIG. 6. with the spigot assembly in an open configuration; and

FIG. 18 is a partial, cross-sectional view of the container taken through line 18-18 of FIG. 2.

Before the embodiments of the disclosure are explained in detail, it is to be understood that the disclosure is not limited in its application to the details of construction and the arrangement of the components set forth in the following description or illustrated in the drawings. Aspects of the disclosure are capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

The features, aspects and advantages are described below with reference to the drawings, which are intended to illustrate but not to limit the present disclosure. While the systems disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximate” mean plus or minus 5% of the number or value that each term precedes. In the drawings, like reference characters denote corresponding features consistently throughout the drawings. Also, while the terms “front side,” “back side,” “top,” “base,” “bottom,” “side,” “forward,” and “rearward” and the like may be used in this specification to describe various example features and elements, these terms are used herein as a matter of convenience, e.g., based on the example orientations shown in the figures and/or the orientations in typical use. Unless otherwise stated, nothing in this specification should be construed as requiring a specific three dimensional or spatial orientation of structures in order to fall within the scope of the claims.

In the description that follows, reference is made to one or more container structures. It is contemplated that any of the disclosed structures may be constructed from any polymer, composite, plastic, injection molded plastic, and/or metal/alloy material, without departing from the scope of the disclosure. Additionally, it is contemplated that any manufacturing methodology may be utilized, without departing from the scope of the disclosure. For example, one or more of welding, e.g., high frequency, ultrasonic welding, or laser welding of fabric, or metal/alloy welding, gluing, stitching, molding, injection molding, blow molding, stamping, deep-drawing, casting, die-casting, rotational molding, or additive manufacturing processes may be used, as well as various finishing processes, including drilling, deburring, grinding, polishing, sanding, or etching processes, among many others, may be utilized to construct the various container structures, or portions thereof, described throughout the disclosure.

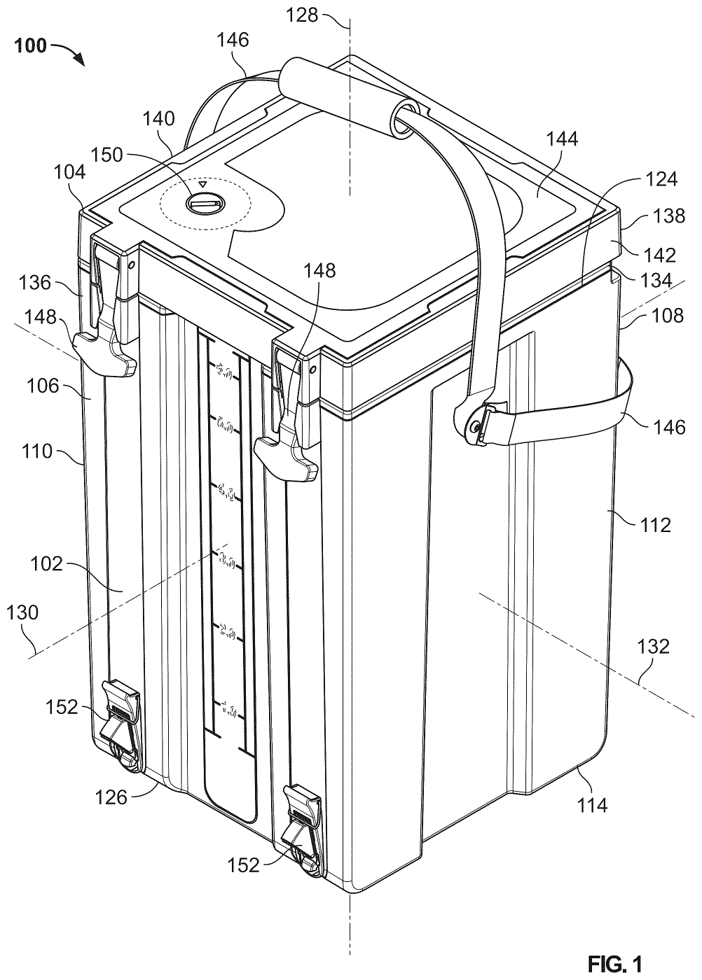

FIGS. 1-6 illustrate various aspects of an implementation of a container 100, which may be configured as an insulating container, a cooler, or an insulative enclosure, according to a first embodiment of the present disclosure. In some applications, the container 100 is configured for transport, protection, and thermal insulation of one or more beverage containers (not shown) or a free fluid. It should be understood, however, that the teachings herein are not limited to any particular beverage container, and are applicable to enclosures for containers of other products, including solids and liquids of various forms, temperatures, and compositions according to a first aspect of the present disclosure. In some aspects, the container 100 comprises a shell or base 102 and a lid 104. The base 102 includes a front wall 106, a rear wall 108, a left wall 110, and a right wall 112, each of which extend upwardly from a bottom wall 114.

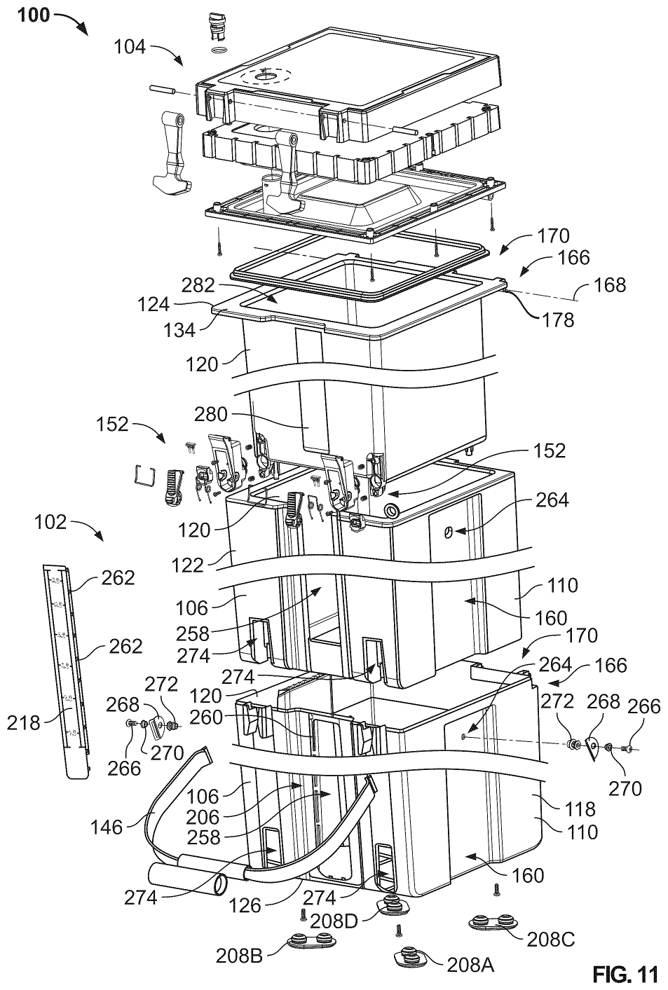

In some aspects, each of the front, rear, left, right and bottom walls 106, 108, 110, 112, 114 of the base 102 are substantially planar walls. The base 102 of the container is configured as a base assembly that includes a base outer wall 118, a base inner wall 120, and a base insulation layer 122, which are best shown and described in relation to FIG. 11. Referring again to FIGS. 1-6, the base 102 can have a top or first end 124 and a bottom or second end 126 that is opposite the first end 124. In some aspects, the container 100 defines a y-axis 128 that extends between the first end 124 and the second end 126, a z-axis 130 that extends between the front wall 106 and the rear wall 108 in a direction that is perpendicular to the y-axis 128, and an x-axis 132 that extends between the left wall 110 and the right wall 112 in a direction that is perpendicular to the y-axis 128 and the z-axis 130. It is contemplated that the y-axis 128, the z-axis 130, and the x-axis 132 define corresponding planes of the container 100. For example, a YZ plane (not shown) extends along the y-axis 128 and the z-axis 130, a YX plane (not shown) extends along the y-axis 128 and the x-axis 132, and a ZX plane (not shown) extends along the z-axis 130 and the x-axis 132.

At the first end 124 of the base 102, there is a base rim 134 that that extends along the periphery of the top of the front, rear, left, and right walls 106, 108, 110, 112 of the base 102. In particular, the base rim 134 is integral with the structure of the base 102 and serves as a connection point between the base 102 and the lid 104. In some aspects, the lid 104 is configured as a lid assembly and includes a front wall 136 a rear wall 138, a left wall 140, and a right wall 142, each of which extend downwardly from a top wall 144. In some aspects, each of the front, rear, left, right and bottom walls 136, 138, 140, 142, 144 of the lid 104 are substantially planar walls. The lid 104 is movably coupled to the base 102, such that when the lid 104 is in a closed position, i.e., when the lid 104 is secured to the base outer wall 118 through a fastening means, each of the walls 106, 108, 110, 112 of the base 102 are flush with the corresponding walls 136, 138, 140, 142 of the lid 104, respectively. Put another way, when the lid 104 is in a closed position as illustrated in FIGS. 1-6, the front wall 106 of the base 102 and the front wall 136 of the lid 104 at least partially define a shared plane, the rear wall 108 of the base 102 and the rear wall 138 of the lid 104 at least partially define a shared plane, the left wall 110 of the base 102 and the left wall 140 of the lid 104 at least partially define a shared plane, and the right wall 112 of the base 102 and the right wall 142 of the lid 104 at least partially define a shared plane.

In some aspects, the container 100 defines a substantially rectangular profile that is configured to be stackable with other similar containers. In some aspects, containers with different volumes have similar footprints to facilitate stability when arranged in a stacked configuration. For example, a first container defines a first volume and a second container defines a second volume that is different from the first volume, but each have similar footprint dimensions, e.g., maximum depth and width dimensions along a base of each container, relative to one another. Put another way, the first and second containers have similar top-down profiles, or footprints. As an example, when first and second containers are arranged in a vertically stacked configuration, only a single container, i.e., the top container, is visible when viewed from a top-down perspective. Accordingly, the stability of containers arranged in a stacked configuration can be enhanced, which is particularly advantageous when storing multiple containers. In some aspects, the container 100 includes rounded corners, or, specifically, rounded bottom corners at the second end 126 of the container 100. The rounded bottom corners make it easier to tip the container forward and/or backward, which may enhance dispensing as will be discussed in greater detail below.

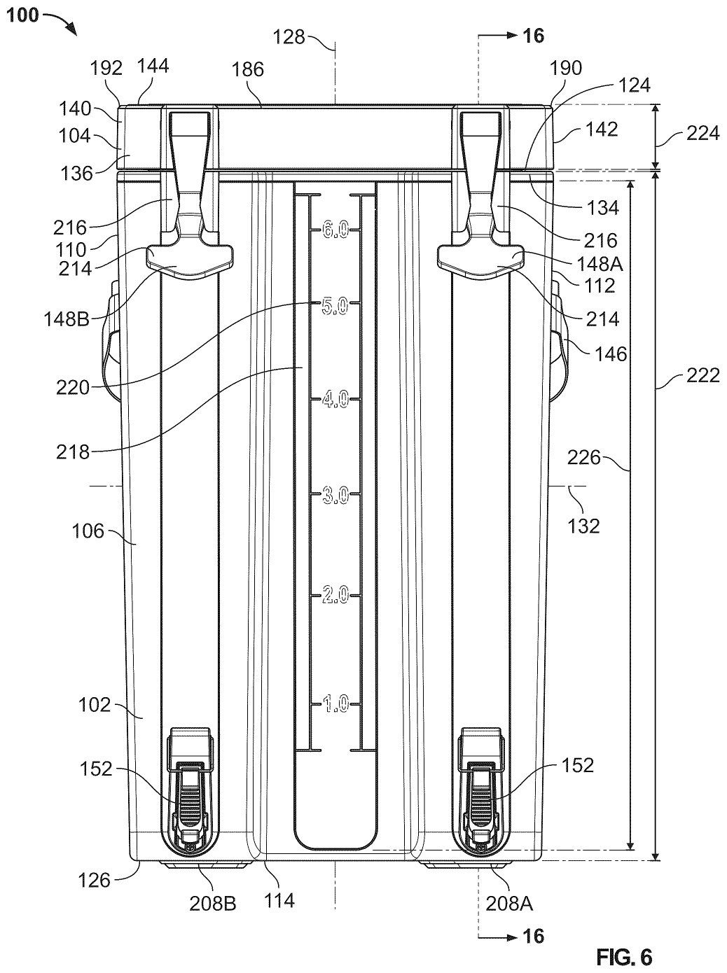

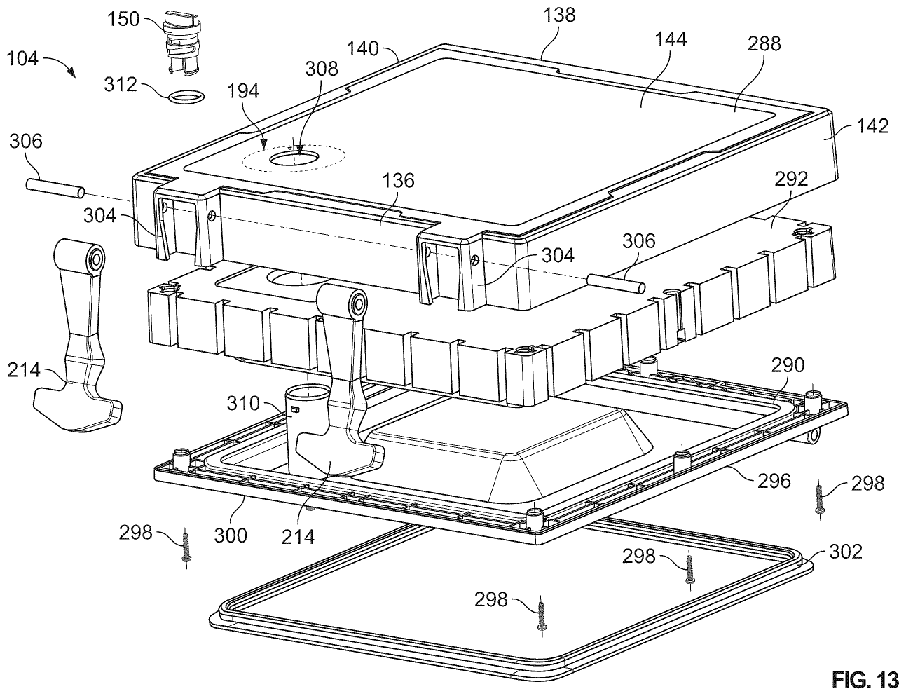

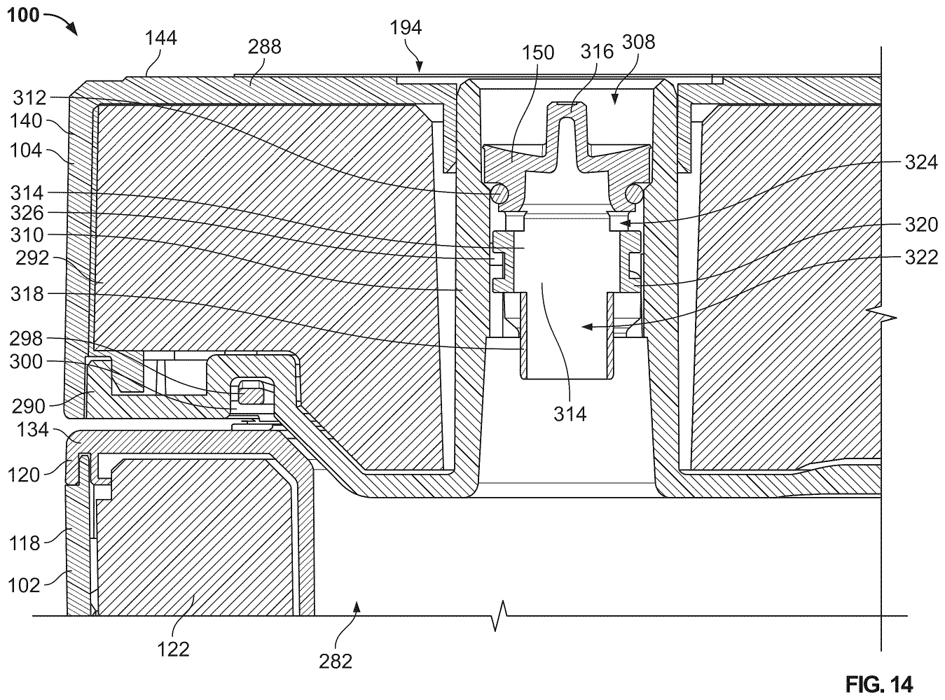

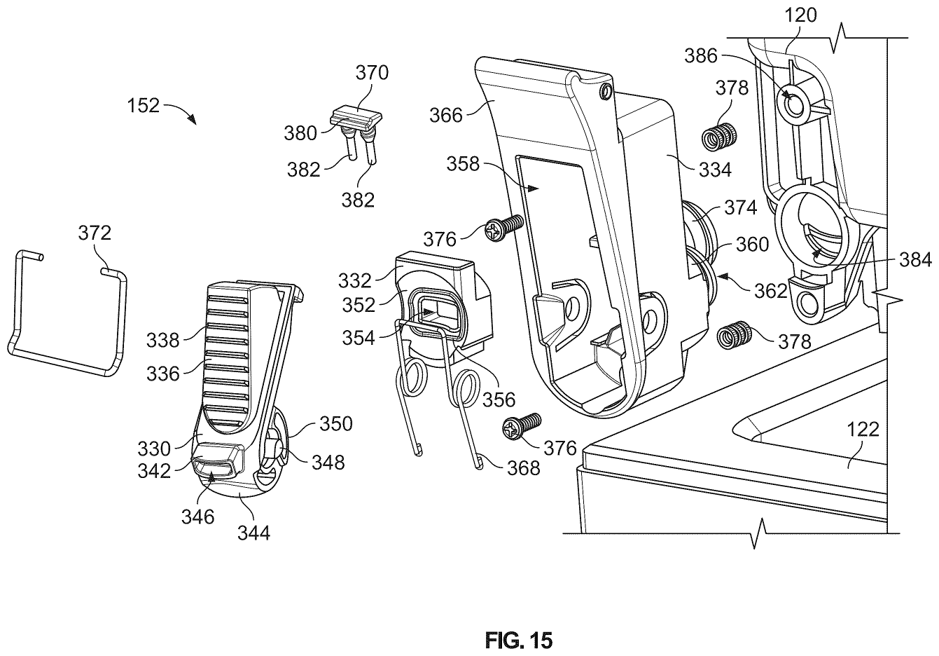

In some aspects, the container 100 further includes one or more straps 146 and lid fasteners 148, as shown and described in relation to FIGS. 6 and 11 below. In some aspects, the container 100 further includes a valve 150, as shown and described in relation to FIGS. 13 and 14 below. In some aspects, the container 100 further includes one or more spigots 152, as shown and described in relation to FIGS. 15-17 below.

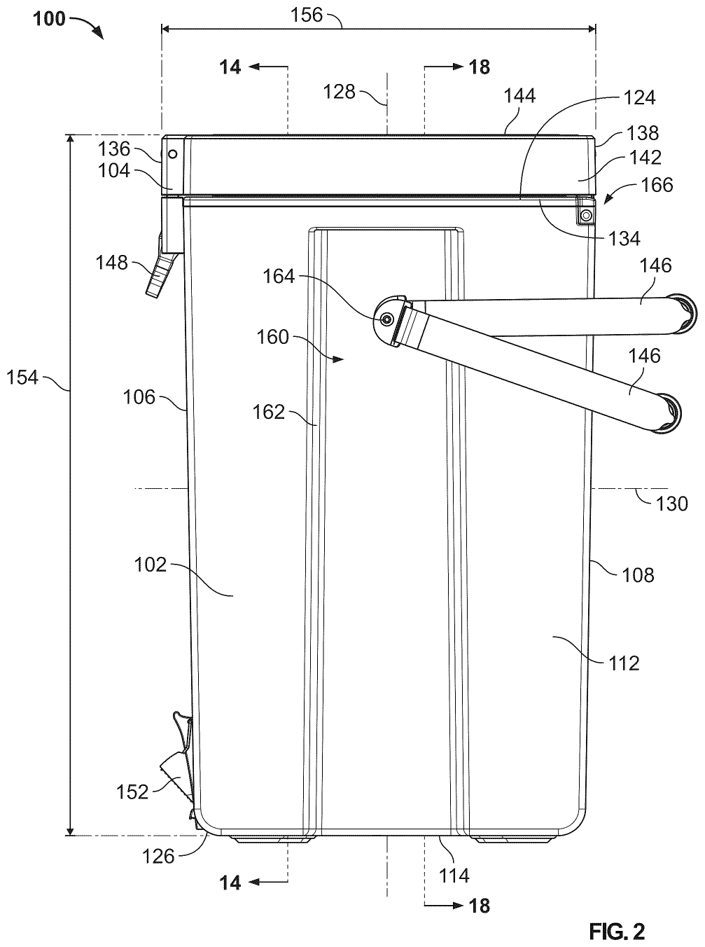

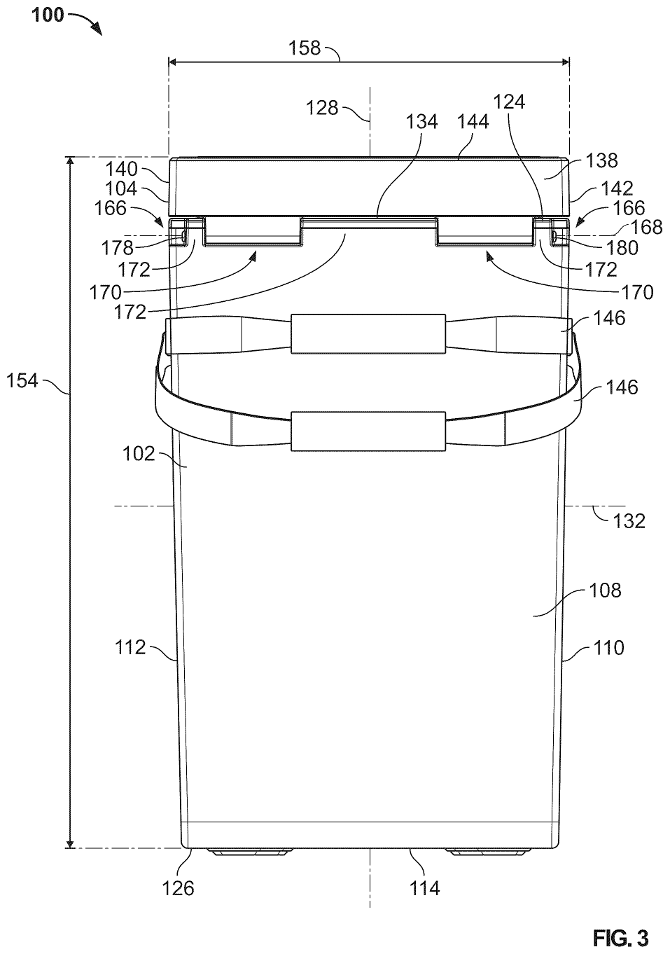

Referring specifically to FIGS. 2 and 3, side and rear elevational views, respectively, are illustrated of the container 100. It is contemplated that aspects relating to the right wall 112 of the base 102 as described herein are also applicable to the left wall 110. As discussed above, the y-axis 128 extends between the first end 124, i.e., the top wall 144, and the second end 126, i.e., the bottom wall 114, of the container 100, the x-axis 132 extends the left wall 110 and the right wall 112 of the base 102, and the z-axis 130 extends between the front wall 106 and the rear wall 108 of the base 102. Various dimensions of the container 100 are shown, including an external height 154 of the container 100, an external depth 156 of the container 100, and an external width of the container 100. Each of the external height, depth, and width 154, 156, 158 of the container 100 are measured along the y-axis 128, the z-axis 130, and the x-axis 132, respectively. As such, it will be appreciated that a height may be measured in a direction that is parallel with respect to the y-axis 128, a depth may be measured in a direction that is parallel with respect to the z-axis 130, and a width may be measured in a direction that is parallel with respect to the x-axis 132. In the illustrated embodiment, the external height 154 is illustrated as a maximum height of the container 100 in a closed configuration, the external depth 156 is illustrated as a maximum depth of the container 100 in a closed configuration, and the external width 158 is illustrated as a maximum width of the container 100 in a closed configuration.

In some aspects, the external depth 156 of the container 100 may be between about 50% and about 100% of the external height 154, or between about 60% and about 80% of the external height 154, or between about 55% and about 65% of the external height 154, or between about 75% and about 85% of the external height 154, or about 80% of the external height 154, or about 60% of the external height 154 of the container 100. In some aspects, the external width 158 of the container 100 may be between about 30% and about 80% of the external height 154, or between about 40% and about 70% of the external height 154, or between about 55% and about 65% of the external height 154, or between about 75% and about 85% of the external height 154, or, about 55% of the external height 154, or about 60% of the external height 154 of the container 100.

Referring specifically to the non-liming example illustrated in FIG. 2, the right wall 112 of the base 102 includes a substantially central rectangular side recess 160 formed therein. The central rectangular side recess 160 includes one or more concave contour edges 162 formed within the right wall 112 and a strap aperture (see FIG. 11) in which a fastener 164 is received to secure the one or more straps 146 to the container 100, as will be discussed in greater detail below. In addition, the right wall 112 includes a corner recess 166 formed at an upper right-hand corner thereof. Put another way, the corner recess 166 is formed at an interface between the right wall 112 with the rear wall 108 at the first end 124 of the container 100.

Referring specifically to FIG. 3, the rear wall 108 of the base 102 includes one or more hinge recesses 170 formed at the first end 124, which extend along a hinge axis 168 that extends in a direction that is parallel with the x-axis 132. In some aspects, the one or more hinge recesses 170 are provide in the form of rectangular recesses that are dimensioned to receive one or more correspondingly shaped hinge protrusions 172. The hinge protrusions 172 are formed integrally with the lid 104 and extend downwardly from the rear wall 138 of the lid 104, and, in some aspects, the hinge protrusions 172 are rectangular protrusions that correspond to the shape of the hinge recesses 170. In addition, the hinge recesses 170 and the hinge protrusions 172 can include hinge apertures (not shown) formed therein, which extend along the hinge axis 168 and are configured to receive an axle or rod therein, or two separate rods, e.g., a first hinge rod 178 and a second hinge rod 180. It is contemplated that any suitable number of rods may be secured within the hinge apertures (not shown) to allow the lid 104 to rotate about the hinge axis 168 when, e.g., the lid 104 is opened or closed.

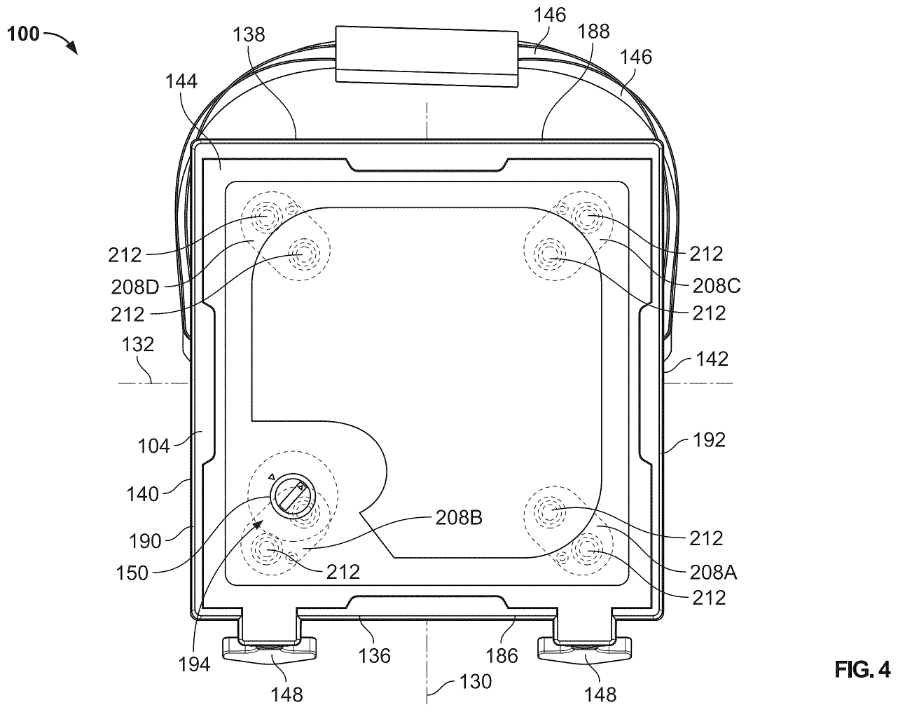

Referring specifically to FIG. 4, the top wall 144 of the lid 104 is substantially rectangular-shaped or square-shaped, although it is contemplated that the top wall 144 can be shaped differently than shown. In particular, the top wall 144 has a front edge 186 along which the front wall 136 is connected to the top wall 144, a rear edge 188 along which the rear wall 138 is connected to the top wall 144, a left edge 190 along which the rear wall 138 is connected to the top wall 144, and a right edge 192 along which the rear wall 138 is connected to the top wall 144. In some aspects, the front, rear, left, and right edges 186, 188, 190, 192 of the top wall 144 are substantially curved edges. Additionally, the top wall 144 includes one or more recessed portions formed thereon, such as a valve recess 194. As discussed above, the container 100 includes the valve 150 which extends through the lid 104, including through the top wall 144. In some aspects, the valve recess 194 surrounds the valve 150 in the top wall 144. In some aspects, the valve 150 and the valve recess 194 are disposed at a corner of the top wall 144. Put another way, the valve 150 and the valve recess 194 are offset with respect to the z-axis 130, the x-axis 132, and one or more of the front, rear, left, and right edges 186, 188, 190, 192 of the top wall 144. For example, the valve 150 and the valve recess 194 are both offset with respect to the front and left edges 186, 190. In some aspects, it is particularly advantageous for the valve 150 and the valve recess 194 to be disposed at a corner of the lid 104, such as, e.g., when the container 100 is tilted to pour or drain a fluid through the valve 150. Further aspects of the valve 150 are best shown and described below in relation to FIGS. 13 and 14.

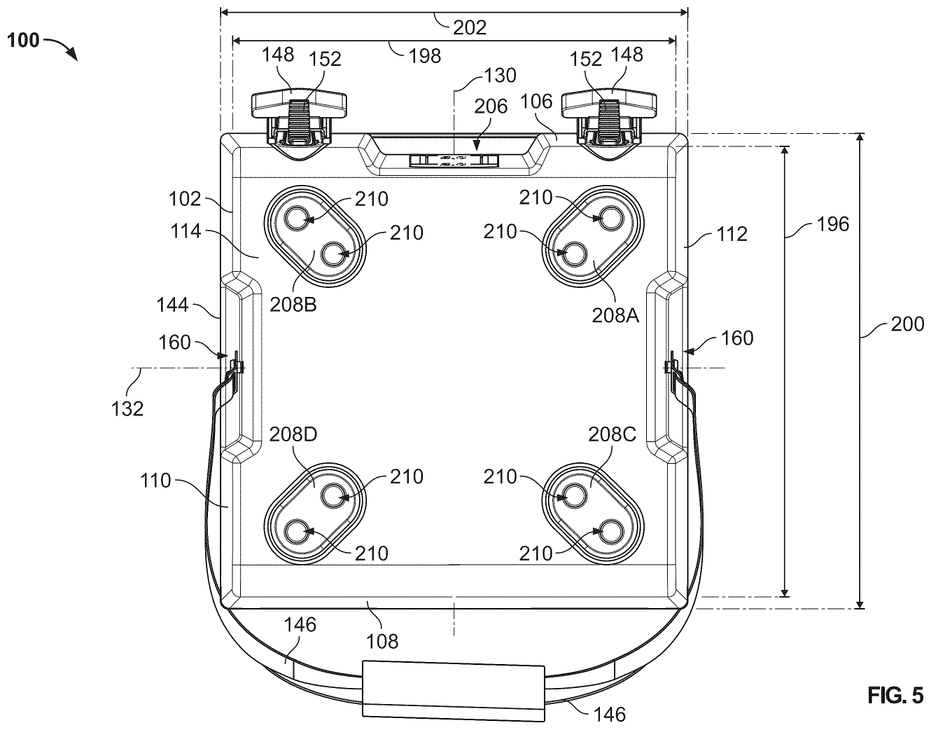

Referring specifically to FIG. 5, a bottom plan view is illustrated of the container 100. In some aspects, the bottom wall 114 of the base 102 is substantially rectangular-shaped or square-shaped, although it is contemplated that the bottom wall 114 can be shaped differently than shown. In some aspects, a depth 196 and width 198 of the bottom wall 114 are each less than a depth 200 and width 202 of the top wall 144, respectively. In some examples, the depth 196 of the bottom wall 114 measured along the z-axis 130 may be between about 75% and about 100% of the depth 200, or between about 80% and about 90% of the depth 200, or about 85% of the depth 200, or about 90% of the depth 200 of the top wall 144. In some examples, the width 198 of the bottom wall 114 measured along the x-axis 132 may be between about 80% and about 100% of the width 202, or between about 90% and about 100% of the width 202, or about 95% of the width 202 of the top wall 144. Accordingly, each of the front, rear, left, and right walls 106, 108, 110, 112 of the base 102 extend upwardly from the bottom wall 114 in a direction that is offset from the y-axis 128 between about 0 degrees and about 15 degrees, or between about 2.5 degrees and about 10 degrees, or about 5 degrees.

As discussed above with respect to FIG. 2, the left and right side walls 110, 112 of the base 102 include central rectangular side recess 160 formed therein. Still referring to FIG. 5, the central rectangular side recess 160 is also formed along the bottom wall 114 of the base 102. As will be discussed in greater detail below, a central rectangular front recess 206 can be formed within the front wall 106 and extend through the bottom wall 114 in similar way to the central rectangular side recesses 160. In addition, one or more foot pads 208 are coupled or secured to the bottom wall 114 arranged at corners thereof. For example, first, second, third, and fourth foot pads 208A, 208B, 208C, 208D are each fastened to the bottom wall 114 at different corners thereof. The foot pads 208 extend downwardly from the bottom wall 114 so as to raise the container 100 above the ground or another surface, such as other containers in stacking configurations, as discussed above. In this way, the foot pads 208 prevent the bottom wall 114 from directly contacting the ground when the container 100 is placed upright, which can reduce wear on the bottom wall 114. In addition, each of the foot pads 208 includes one or more circular pad recesses 210 which extend upward through the foot pads 208.

Referring briefly again to FIG. 4, the foot pads 208 are illustrated in dashed lines to represent example positions thereof with respect to the top wall 144 of the lid 104 and the valve 150 when multiple containers are arranged in a vertically stacked configuration. It is contemplated that, when multiple containers are arranged in the vertically stacked configuration, the y-axis 128 of each container 100 can be coaxially aligned with one another so that the foot pads 208 are configured to contact the top wall 144 of the lid 104 in the example positions of FIG. 4. In particular, the second foot pad 208B may be arranged to overlap the valve recess 194. In some aspects, the second foot pad 208B straddles the valve recess 194 but does not extend into the valve recess 194 or contact the valve 150 therein. Specifically, and as will be discussed in greater detail below, the valve 150 is located within the valve recess 194 that is formed within the top wall 144 of the lid 104, such that the valve 150 is vertically recessed relative to the top wall 144. Relatedly, the food pads 208 elevate the bottom wall 114 of the base 102. In this way, the valve recess 194 and the foot pads 208 cooperate to provide spacing between vertically stacked containers, thereby providing an air flow path for the valve 150, even in stacked configurations.

In addition, it is contemplated that the foot pads 208 each include circular pad protrusion 212 which correspond to the pad recesses 210 (see FIG. 5). The pad protrusions 212 are each inserted into correspondingly shaped apertures (not shown) defined in the bottom wall 114 of the base 102 to fasten the foot pads 208 to the base. In some aspects, the foot pads 208 are each formed as unitary components from injection molded plastic, such as, e.g., polypropylene (“PP”), homopolymer PP, Copolymer PP, Random Copolymer, thermoplastics, and/or any other plastics or polyolefins, or combinations thereof.

Referring now to FIG. 6, a front elevational view is illustrated of the container 100 in a closed configuration. As discussed above, the container 100 includes one or more lid fasteners 148, such as a first lid fastener 148A and a second lid fastener 148B. In some aspects, the lid 104 is removably attached to the base 102 by the lid fasteners 148, which include a latch 214 and a latch restrainer 216 that function as a closure mechanism. The latches 214 may be provided in a shape resembling a “T” and made of silicon, rubber, or another durable, elastomeric or rubber-like material. The latch restrainers 216 are generally integrally formed or molded with the front wall 106 of the base 102 or the base rim 134. In some aspects, the container 100 may use a zipper, a rail-type closure mechanism, a hook and loop fastener, a tab, an interference fitting closure mechanism, an interlocking closure mechanism, a magnetic closure mechanism, or any other suitable type of fastener, without departing from the scope of these disclosures.

In the non-limiting example illustrated in FIG. 6, the lid fasteners 148 are each offset from the y-axis 128 and the left and right walls 110, 112. Put another way, the first lid fastener 148A is disposed on the front walls 106, 136 and offset with respect to the left wall 110 and the y-axis 128. Correspondingly, the second lid fastener 148B is disposed on the front walls 106, 136 and offset with respect to the right wall 112 and the y-axis 128. Advantageously, the container 100 can further include one or more spigots 152, such as a first spigot 152A and a second spigot 152B that are each coupled to the front wall 106 of the base 102 at the second end 126 of the container 100. In some aspects, the spigots 152 are horizontally aligned with the lid fasteners 148 with respect to the y-axis 128, meaning that the first spigot 152A is horizontally aligned with the first lid fastener 148A, and the second spigot 152B is vertically aligned with the second lid fastener 148B relative to the y-axis 128. Put another way, the first spigot 152A and first lid fastener 148A are aligned along a first vertical axis that is parallel with and offset laterally from the y-axis 128, and the second spigot 152B and second lid fastener 148B are aligned along a second vertical axis that is parallel with and offset laterally from the y-axis 128. In some aspects, the use of multiple spigots 152 is desirable to allow more than one user can use the container 100 at the same time, e.g., two users filling up water bottles, a user filling up multiple water bottles. Further, the use of multiple spigots 152 permits selectively configurable flow rate control of fluid out of the container 100. For example, the spigots 152 define a first dispensing configuration in which the first spigot 152A is opened and the second spigot 152B is closed, thus providing a first dispensing rate. In a similar way, a second dispensing configuration is realized when the first spigot 152A and the second spigot 152B are open, thus providing a second dispensing rate that is greater than the first dispensing rate. However, it is contemplated that the spigots 152 may provide for intermediary dispensing configurations and corresponding intermediary dispensing rates as well, e.g., a third dispensing rate that is greater than the first dispensing rate and less than the second dispensing rate.

The container 100 further includes a fill level insert or component 218 that is coupled or secured to the front wall 106 of the base 102. In some aspects, the fill level component 218 is a substantially transparent, rectangular component which may be formed of a thermoplastic polymer such as polypropylene or another type of plastic. The fill level component 218 is centrally secured to the front wall 106 of the base 102, and, in particular, secured within the central rectangular front recess 206. In some aspects, the fill level component 218 is secured to the base 102 using adhesive, fasteners, fastening tabs or another suitable fastening method, as will be discussed below in greater detail. In some aspects, the fill level component 218 is disposed laterally between the first the first lid fastener 148A and the second lid fastener 148B, and the fill level component 218 is disposed laterally between the first spigot 152A and the second spigot 152B. The fill level component 218 includes horizontal gradient lines 220 disposed thereon, which correspond to volume or content levels of the container 100. For example, the horizontal gradient lines 220 denote the number of gallons, e.g., 1.0, 2.0, 3.0, 4.0, 5.0, 6.0, etc., corresponding to specific volumes of the container 100. In this way, the fill level of the container 100, i.e., the amount of fluid contained in the container 100, can be visualized without having to open the lid 104 and expose the contents of the container 100 to the environment. This is particularly advantageous when the container 100 is being used to contain a free liquid, e.g., water or a sports drink. To that end, it becomes possible to see the level of fluid in the container 100 before, during and after fluid is added to or removed from the container 100, such as instances in which fluid is drained through the spigots 152 and/or the valve 150 as will be discussed below in greater detail. While the fill level component 218 is illustrated as denoting a specific number of gallons, it is contemplated that any suitable gradient scale or set of symbols can be used to denote different volumes or other dimensions of the container.

Still referring to the non-limiting example illustrated in FIG. 6, additional dimensions of the container 100 are shown, including a height 222 of the base 102, a height 224 of the lid 104, and a height 226 of the fill level component 218. Each of the base, lid, and fill level component heights 222, 224, 226 are measured along the y-axis 128. In some aspects, the external height 154 is defined by the height 222 of the base 102 added to the height 224 of the lid 104. In some aspects, the height 224 of the lid 104 may be between about 1% and about 25% of the height 222, or between about 5% and about 15% of the height 222, or between about 5% and about 10% of the height 222, or about 8.5% of the height 222 of the base 102. In some aspects, the height 226 of the fill level component 218 may be between about 75% and about 100% of the height 222, or between about 80% and about 90% of the height 222, or between about 85% and about 90% of the height 222, or about 88% of the height 222 of the base 102.

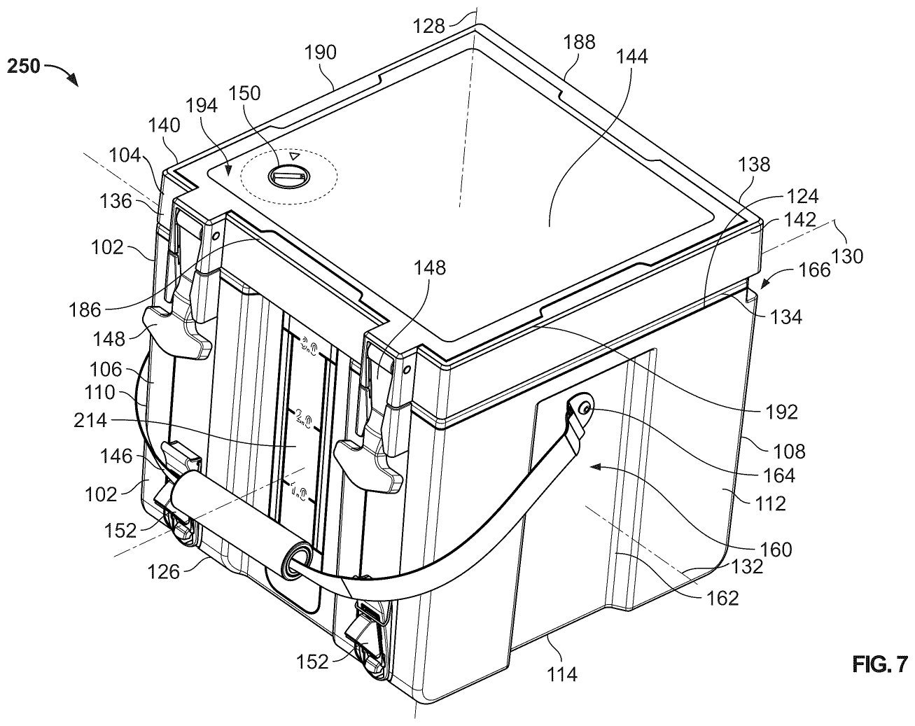

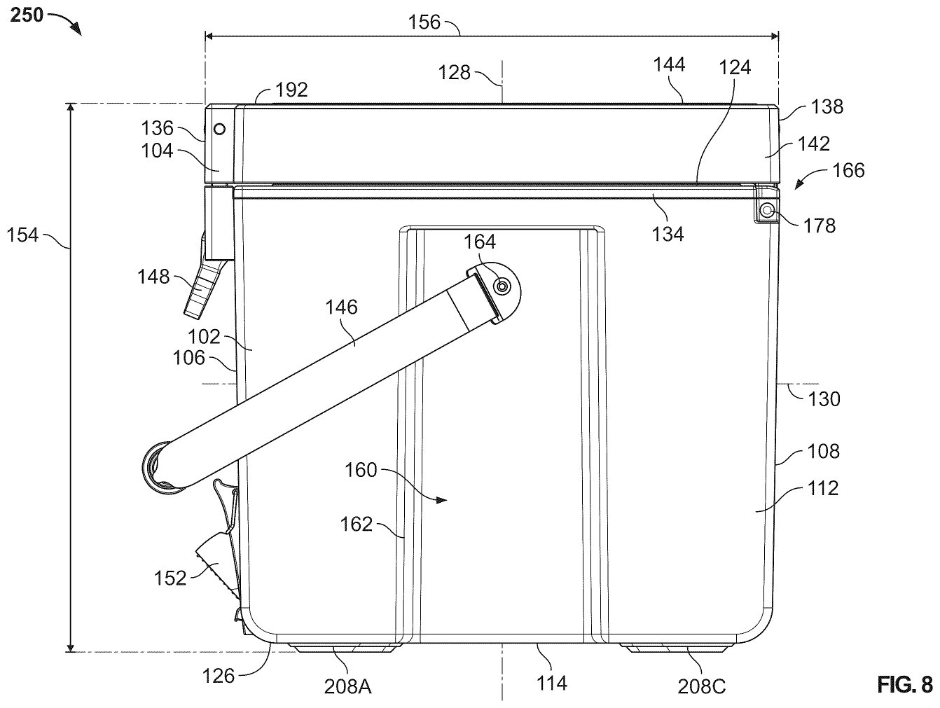

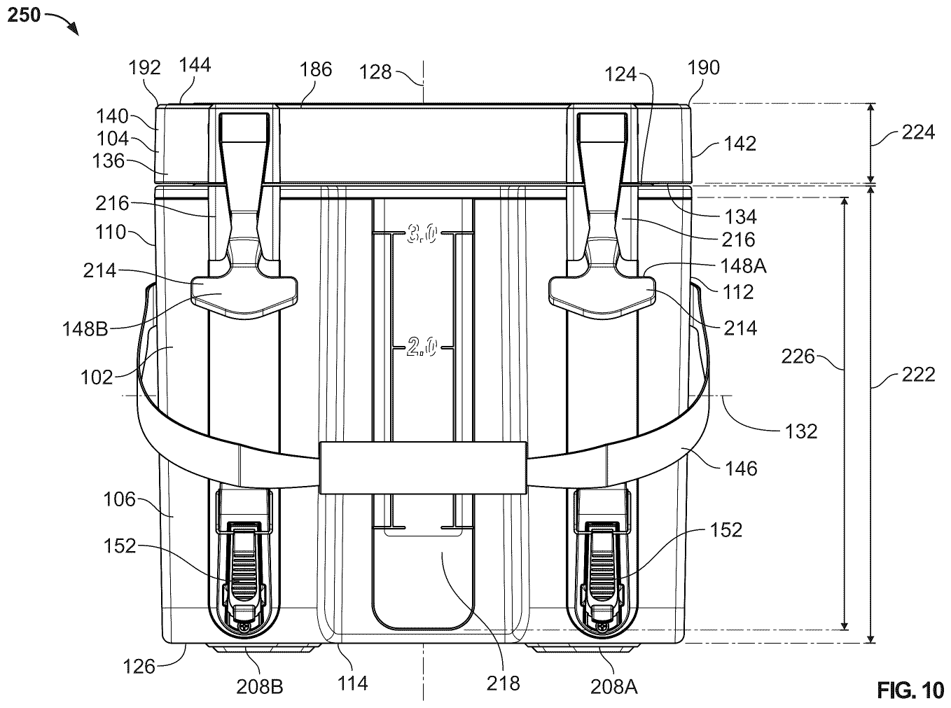

FIGS. 7-10 illustrate various aspects of an implementation of an enclosure or container 250, according to a second aspect of the present disclosure. In this embodiment, elements that are shared with—i.e., that are structurally and/or functionally identical or similar to—elements present in the first embodiment (container 100) are represented by like reference numerals. In the interest of brevity, some features of this embodiment that are shared with the embodiment of FIGS. 1-6 are numbered or labeled in FIGS. 7-10 but are not discussed in the specification. However, reference is made to a list of reference numerals used in the description herein.

While the base 102, the lid 104, and the fill level component 218 of the containers 100, 250 have varying heights 154, 222, 224, 224, depths 156, and widths 158 these differences relate to the particular capacity and internal volume of the containers 100, 250, and the desired amount of fluid, beverage containers, or other material(s) that can be placed into the container 100, 250. However, the various dimensional relationships between the external height, depth, and width 154, 156, 158, the base 102, the lid 104, and the fill level component 218 of the containers 100, 250 may vary within the following ranges.

In some aspects, the external depth 156 of the container 250 may be between about 100% and about 125% of the external height 154, or between about 105% and about 115% of the external height 154, or between about 105% and about 110% of the external height 154, or between about 110% and about 115% of the external height 154, or about 110% of the external height 154 of the container 250. In some aspects, the external width 158 of the container 250 may be between about 75% and about 125% of the external height 154, or between about 90% and about 110% of the external height 154, or between about 95% and about 105% of the external height 154, or between about 95% and about 100% of the external height 154, or between about 100% and about 105%, or about 100% of the external height 154 of the container 250. In some aspects, the height 224 of the lid 104 may be between about 1% and about 25% of the height 222, or between about 10% and about 20% of the height 222, or between about 15% and about 20% of the height 222, or about 17% of the height 222 of the base 102. In some aspects, the height 226 of the fill level component 218 may be between about 75% and about 100% of the height 222, or between about 85% and about 95% of the height 222, or between about 90% and about 95% of the height 222, or about 93% of the height 222 of the base 102.

FIG. 11 illustrates an exploded view of the first embodiment (container 100). As discussed above, elements of the first embodiment (container 100) that are shared with—i.e., that are structurally and/or functionally identical or similar to—elements present in the second embodiment (container 250) are represented by like reference numerals. In the interest of brevity, some features of this embodiment that are shared with the embodiment of FIGS. 7-10 are numbered or labeled in FIG. 11 but are not discussed in the specification.

The base 102 of the container 100 can include a base outer wall 118, a base inner wall 120, and a base insulation layer 122. In some aspects, the base outer wall 118, base inner wall 120, and base insulation layer 122 are substantially rectangularly shaped and are open on one end, e.g., the top or first end 124. When the container 100 is assembled, the base inner wall 120 is received and secured within the base insulation layer 122, and the base insulation layer 122 is received and secured within the base outer wall 118. In some aspects, the base outer wall 118 and base insulation layer 122 each define one or more recesses on outer surfaces thereof, such as the central rectangular side recesses 160, the corner recesses 166, the hinge recesses 170, and the central rectangular front recess 206. Further, the base outer wall 118 and base insulation layer 122 each define central front openings, e.g., central apertures or central recesses, that are substantially rectangular shaped and are configured to receive the fill level component 218. Specifically, the base outer wall 118 defines a substantially rectangular, central, and front aperture or opening 258 and includes a plurality of rectangular fastening posts 260 disposed therearound. Correspondingly, the fill level component 218 includes a plurality of fastening tabs 262 around a periphery thereof that are dimensioned to be received in between the rectangular fastening posts 260 on the base outer wall 118. It is contemplated that any suitable method may be used to secure the fastening tabs 262 in between the rectangular fastening posts 260, e.g., cement, epoxy, adhesives, etc.

Still referring to FIG. 11, the base outer wall 118 and base insulation layer 122 further define handle apertures 264 in left and right walls thereof, i.e., the left and right walls 110, 112 of the container 100. In particular, the handle apertures 264 extend through the left and right walls 110, 112 of the container, within the central rectangular side recesses 160. The handle apertures 264 are used in combination with one or more fasteners to couple or secure one or more handles to the container. Specifically, the straps 146 are rotatably fastened or secured to the left and right walls 110, 112 of the base 102 at the handle apertures 264, such that the straps 146 are able to rotate or swivel about the attachment points defined by the handle apertures 264. For example, the straps 146 are secured to the container 100 by fastening one or more fasteners 266, e.g., screws, bolts, pins, etc., swivel clips 268, and swivel clip bushings 270 within the handle apertures 264 using swivel clip pins 272.

Put another way, the fasteners 266 are inserted through ends of the straps 146, the swivel clip 268, the swivel clip bushings 270, and the handle apertures 264 before being fastened to the swivel clip pins 272. In this way, the straps 146 are able to rotate about the fasteners 266 via the swivel clips 268. As will be discussed in greater detail below, the container 100 may have a volume of 3 gallons or 6 gallons, which, when filled with water, weighs about 25 pounds or 50 pounds, respectively. Accordingly, rotating the straps 146 via the swivel clips 268 permit the straps 146 makes it possible to carry the container 100, e.g., over a shoulder or alongside a body with an outstretched arm, when filled. In addition, carrying the container 100 via the rotatable straps 146 also functions to level the container 100, which is particularly useful when carrying fluids. Further, rotating the straps 146 via the swivel clips 268 allows the straps 146 to be stowed behind the container 100 (e.g., on the rear wall 108 of the base 102) to keep the front face 106 of the base 102 and the fill level component 218 uncovered. Ensuring that the fill level component 218 remains visible permits users to identify the contents in the container 100, as will be discussed below in greater detail.

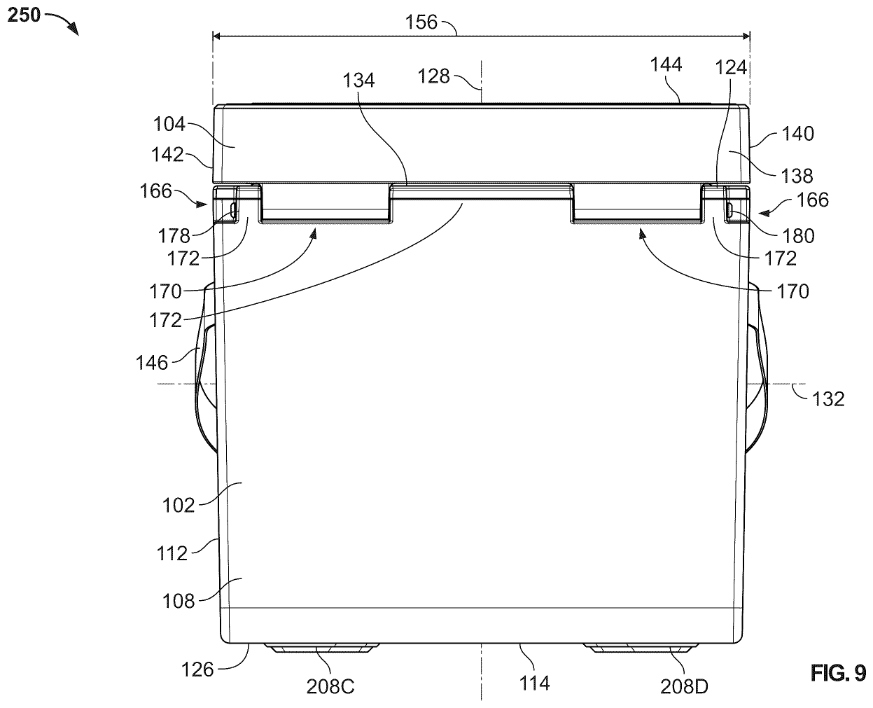

The straps 146 may be formed of webbing, such as, e.g., nylon webbing, or other materials that may include, among other, polypropylene, neoprene, polyester, Dyneema, Kevlar, cotton fabric, leather, plastics, rubber, or rope. While FIG. 9 illustrates the container 100 as including both the first strap 146A and the second strap 146B, it is contemplated that fewer or additional straps may be coupled to the containers 100, 250. For example, the container 250 only includes the first strap 146A as illustrated in FIGS. 7-10.

Still referring to FIG. 11, the base outer wall 118 and base insulation layer 122 further define one or more spigot apertures 274 which correspond to the spigots 152 and are configured to receive the spigots 152 therein when the container 100 is assembled. The spigot apertures 274 generally extend through the front of the base outer wall 118 and base insulation layer 122, i.e., the front wall 106 of the base 102, and are disposed towards the second end 126 of the base 102. While the spigot apertures 274 are illustrated as being substantially rectangular-shaped, it is contemplated that any suitable shape can be used to receive the spigots 152.

The base inner wall 120 is dimensioned to be received within the base insulation layer 122 as discussed above. As discussed above, the base rim 134 is integral with the structure of the base 102 at the first end 124 thereof. More specifically, the base rim 134 is integral with the base inner wall 120 and serves as a connection point between the base outer and inner walls 118, 120. In particular, the base outer and inner walls 118, 120 may be connected to each other along the base rim 134 using one or more screws, locking plugs, rivets, adhesives, or hinge recesses 170 in which the one or more hinge rods 178, 180 (see FIG. 3) are inserted. In this way, the base outer and inner walls 118, 120 are coupled to one another by the hinge rods along the hinge axis 168 defined, in part, by the base rim 134.

Still referring to FIG. 11, the base inner wall 120 further includes a central window 280 disposed within a front wall thereof, e.g., the front wall 106 of the base 102. The central window 280 is a transparent or translucent window through which characteristics of the contents of the container 100 are visible to a user standing in front of and facing the front wall 106. When the container 100 is assembled, the central window 280 is aligned with the central openings defined by the base outer wall 118 and base insulation layer 122, e.g., the rectangular front openings 258, such that the interior of the container 100 is at least partially visible through the fill level component 218. Advantageously, the fill level component 218 allows the level of fluid in the container 100 to be monitored before, during, and after fluid is added thereto or removed therefrom. Further, the central window 280 and the fill level component 218 can also provide users with visibility as to a color or form of the contents in the container 100, such that users can identify what is in the container 100 from a distance without opening the lid 104 or dispensing the contents from the spigot 152 It is contemplated that the central window 280 can be coupled to the base inner wall 120 using any suitable technique as discussed above, or the central window 280 can be formed integrally with the base inner wall 120. In some aspects, the central window 280 is formed of a thermoplastic polymer such as polypropylene or another type of plastic.

The central window 280 and fill level component 218 are further configured to provide visibility of the contents, e.g., fluid level, of the container 100 for quick, at-a-glance monitoring at various distances, vantage points or angles, and conditions, such as, e.g., inclement weather, natural or artificial brightness, shade, or the like. To that end, at least one of the central window 280 or fill level component 218 may be tinted, frosted, or otherwise treated to for enhanced visibility, such as, e.g., to alter glare and reflectivity. In some instances, the central window 280 or fill level component 218 may be configured for directional or targeted visibility, so as to prevent visibility at certain vantage points or angles. In some embodiments, at least one of the central window 280 and fill level component 218 is configured as a plurality of transparent or translucent segments spaced apart from one another in a vertical array along the front wall 106. The fill level component 218 or the front wall 106 may include a slot, recess, or pocket (not shown) for receiving a placard or label corresponding to the contents in the container 100, so as to provide another visual indicator for users.

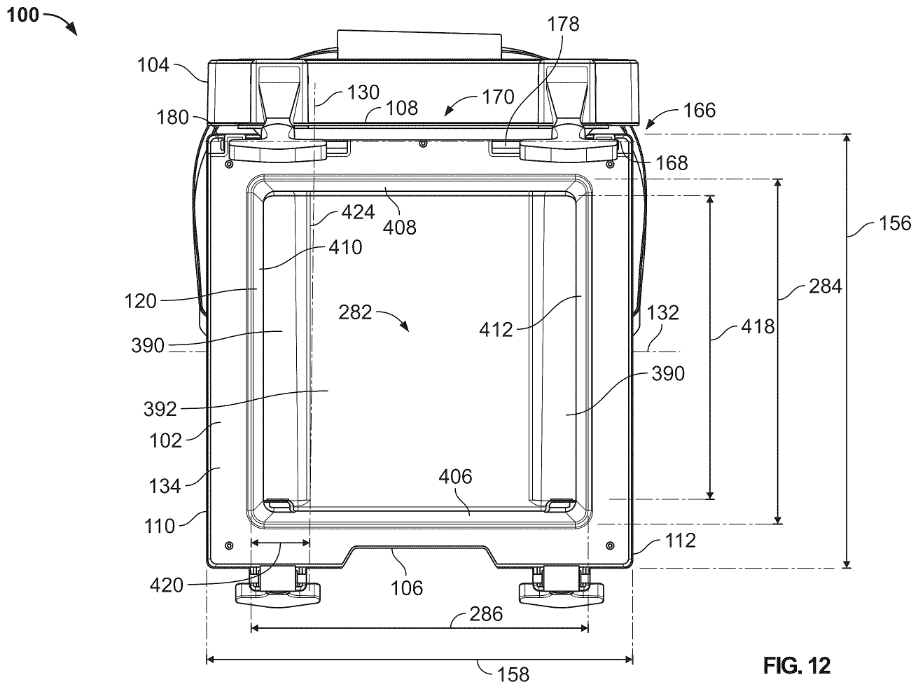

Referring now to FIG. 12, a top plan view is illustrated of the container 100 with the lid 104 in an open configuration. The base inner wall 120 further includes a plurality of walls and defines an internal volume 282 of the container 100 in which fluid, beverage containers, or other objects are contained, as discussed above. In some aspects, the internal volume 282 defines an internal height (not shown), an internal depth 284, and an internal width 286. In some aspects, the internal depth 284 may be between about 75% and about 100% of the external depth 156, or between about 80% and about 90% of the external depth 156, or between about 85% and about 90% of the external depth 156, or about 85% of the external depth 156 of the base 102. In some aspects, the internal width 286 may be between about 75% and about 100% of the external width 158, or between about 75% and about 85% of the external width 158, or between about 80% and about 95% of the external width 158, or about 80% of the external width 158 of the base 102. The internal volume 282 may have a volume that is between about 1 gallon (3.79 liters) and about 25 gallons (94.94 liters), or between about 1 gallon (3.79 liters) and about 15 gallons (56.78 liters), or between 1 gallon (3.79 liters) and about 10 gallons (37.85 liters), or between about 3 gallons (11.36 liters) and about 6 gallons (22.71 liters), or about 3 gallons (11.36 liters), or about 6 gallons (22.71 liters). In some examples, the internal volume 282 is defined by the internal height (not shown), the internal depth 284, and the internal width 286, such that a particular quantity of beverage containers of a standard size are configured to be received in a vertical position and arranged in a grid-like fashion, i.e., m×n. For example, the internal volume 282 may be configured to receive fifteen beverage containers arranged in a three-by-five grid, or thirty-two beverage containers in an eight-by-four grid. However, different quantities of beverage containers may be received within the internal volume 282 and may be arranged differently, such as, e.g., stacked vertically atop one another and/or disposed in horizontal positions below the base rim 134 atop of each of the walls 106, 108, 110, 112 of the base 102 such that the lid 104 can be rotated about the hinge axis 168 to a closed configuration.

Referring now to FIG. 13, an exploded view is illustrated of the lid 104. As discussed above, the lid 104 is configured as a lid assembly including a top portion, an insulation portion, and a bottom portion. For example, the lid 104 includes a lid outer wall 288, a lid inner wall 290, and a lid insulation layer 292. In some aspects, the lid outer wall 288, lid inner wall 290, lid insulation layer 292 are substantially rectangularly shaped. When the container 100 is assembled, the lid inner wall 290 is received and secured within the lid insulation layer 292, and the lid insulation layer 292 is received and secured within the lid outer wall 288. The lid outer and inner walls 288, 290 may be constructed from injection molded plastic, such as, e.g., polypropylene (“PP”), homopolymer PP, Copolymer PP, Random Copolymer, thermoplastics, and/or any other plastics or polyolefins, or combinations thereof. In addition, the lid insulation layer 292 may be made of polyurethane, open-cell or closed-cell foam, or any other known insulative material.

Referring to FIGS. 11 and 13, the insulation layers 122, 292 for both the base 102 and the lid 104 may be made of polyurethane, open-cell or closed-cell foam, or any other known insulative material. The insulation layers 122, 292 may be provided as closed-cell foam insulation of between about 1.0 and about 1.5 inches in thickness (e.g., a height measured along the y-axis 128 (see FIG. 1)) to enable the container 100 for ice retention over extended periods of time, such as, e.g., about 7 hours or more. The insulation layers 122, 292 can be injected between the outer walls 118, 288 and the inner walls 120, 290 during the manufacturing of the container 100, although other configurations are possible. In some embodiments, the insulation layers 122, 292 are placed between the outer walls 118, 288 and inner walls 120, 290 during the manufacturing process.

Referring specifically to FIG. 12, the lid inner wall 290 has a lid rim surface 296 that abuts the internal volume 282 of the base 102 when the lid 104 is in a closed configuration. The lid rim surface 296 is a flat surface which extends around the peripheral of the lid 104. In some aspects, the lid outer wall 288, lid inner wall 290, and insulation layer 292 are secured to each other along the lid rim surface 296 using one or more screws 298 as shown, rivets, adhesive, or any other suitable fastening mechanism known in the art. The lid rim surface 296 is configured such that when the lid 104 is in a closed configuration the lid rim surface 296 abuts the base rim 134. Just within the lid rim surface 296, there is a sealing groove 300 that holds a gasket 302 that extends around inner peripheral of the lid rim surface 296. The gasket 302 is configured to create a generally water- and air-tight seal between the lid 104 and the base 102 when the lid 104 is in a closed configuration and the latches 214 are secured. The seal helps prevent the container 100 from leaking any fluids from within and allows for a slower rate of heat transfer between the internal volume 282 (see FIG. 11) and a surrounding or ambient environment of the container 100. In some examples, the lid 104 is configured to provide an air-tight and water-tight seal between the ambient environment and the internal volume 282 (see FIG. 11), such that the container 100 is configured to be water-resistant and/or waterproof. In some examples, the seal may not be a completely air-tight or water-tight.

Still referring to FIG. 13, the lid 104 further includes one or more latch housings 304 formed integrally on the front wall 136 of the lid 104. In some aspects, the latches 214 are secured within the latch housings 304 by inserting latch rods 306 through the latch housings 304. Accordingly, the latches 214 are able to rotate within the latch housings 304 by way of the latch rods 306. As discussed above, the lid 104 includes the valve 150 and the valve recess 194 that surrounds the valve 150 on the top wall 144 of the lid 104, i.e., the top wall 144 of the lid outer wall 288. The lid further includes a valve aperture 308 that extends through each of the lid outer wall 288, lid inner wall 290, and insulation layer 292, and the valve aperture 308 is disposed at a corner of the lid 104. Put another way, the valve aperture 308 extends longitudinally through the lid 104 in a direction that is parallel with respect to the y-axis 128 (see FIG. 2). In some aspects, the valve aperture 308 is a substantially cylindrical recess. Further, the lid inner wall 290 includes a valve wall 310 which extends upwardly from the lid inner wall 290 and is dimensioned to be received in the valve aperture 308 formed in the lid outer wall 288 and lid insulation layer 292.

In some aspects, the valve 150 is a twist valve with one or more end positions, such as an open configuration and a closed configuration. For example, when the valve 150 is in the open position, an airflow path is defined between the internal volume 282 (see FIG. 11) and the ambient environment. Correspondingly, when the valve 150 is in the closed position, the valve blocks the internal volume 282 (see FIG. 11) of the container 100 from being in fluid communication with the ambient environment. In some aspects, each of the open and closed positions are defined a rotation position of the valve 150 relative to the valve aperture 308. For example, the valve 150 initially in the open position can be rotated about 45 degrees to the closed position to seal the internal volume 282 (see FIG. 11) from being in fluid communication with the ambient environment. However, it is contemplated that the open and closed positions may be defined by any suitable rotation of the valve. In some aspects, the valve 150 includes a marker, e.g., an arrow, which allows a user to visualize the present rotational position of the valve 150 within the valve aperture 308. Further, the top wall 144 and/or the valve recess 194 disposed therein includes a corresponding marker, e.g., an arrow, which, when aligned with the indicator on the valve 150, indicates that the valve 150 is in the open or closed position. In some aspects, one or more valve flanges 312 are arranged on the valve 150 when the valve 150 is disposed within the valve aperture 308, and the one or more valve flanges 312 are configured to provide an air-tight and water-tight seal between the ambient environment and the internal volume 282 (see FIG. 11) when the valve is in the closed configuration.

Referring now to FIG. 14, a partial cross-sectional view is illustrated of the valve 150 secured within the valve aperture 308 of the lid 104 taken through line 13-13 in FIG. 2. The valve 150 has a generally cylindrical, hollow valve body 314 which includes a rectangular tab 316 extending upward therefrom, two arcuately shaped legs 318 extending downward therefrom, and screw threads 320 disposed on the valve body 314 between the rectangular tab 316 and the legs 318. In some aspects, the valve body 314 defines a valve airflow path 322 therethrough. Further, the valve 150 includes an airflow aperture 324 disposed radially through the valve body 314. In some aspects, the valve 150. In some aspects, the valve 150 may be constructed from injection molded plastic, such as, e.g., polypropylene (“PP”), homopolymer PP, Copolymer PP, Random Copolymer, thermoplastics, and/or any other plastics or polyolefins, or combinations thereof.

The rectangular tab 316 extends from the top of the valve body 314 such that a user may grasp the tab and rotate the valve 150 to a desired position. The legs 318 are configured to engage with the valve wall 310 integrally formed with the lid inner wall 290 so as to axially secure the valve 150 within the valve aperture 308. The screw threads 320 permit predetermined circumferential rotation, e.g., about 45 degrees or about 90 degrees between the open position and the closed position, of the valve 150 and engage with correspondingly shaped valve wall threads 326 extending inwardly from the valve wall 310 to radially secure the valve 150 within the valve aperture 308. When the valve 150 is rotated to the open position, the airflow aperture 324 is uncovered, meaning that the airflow path 322 defined through the valve body 314 is placed in fluid communication with the ambient environment through the airflow aperture 324. In this way, the valve 150 permits fluid communication between the ambient environment and the internal volume 282 of the container 100 when the valve 150 is in the open position. When the valve 150 is rotated to the closed position, the airflow aperture 324 is covered, meaning that the airflow path 322 defined through the valve body 314 is blocked from being in fluid communication with the ambient environment. In this way, the valve 150 prevents fluid communication between the ambient environment and the internal volume 282 of the container 100 when the valve 150 is in the closed position.

In some aspects, the valve 150 is disposed entirely within the valve aperture 308 and the valve wall, meaning that the rectangular tab 316 does not extend past the top wall 144 of the lid 104. Advantageously, the valve recess 194 defines a depression within the top wall 144 of the lid 104, which further ensures that the rectangular tab 316 does not extend past the top wall 144 of the lid 104. As discussed above, the valve recess 194 and the foot pads 208 (see FIGS. 4 and 5) provide spacing when containers are stacked on top of one another to ensure that an air flow path still exists between the environment and the valve 150. Additionally, each of the foot pads 208 is spaced inwardly of a perimeter of the second end 126, such that the foot pads 208 are configured to be within the footprint of the containers 100, 250 to permit vertical stacking of like containers on top of one another. Each of the foot pads 208 can be located entirely within the perimeter of the second end 126. In some embodiments, at least one of the foot pads 208 is located entirely within the perimeter of the second end 126, while another of the foot pads 208 is located partially along or protruding from the perimeter of the second end 126.

Referring now to FIGS. 15-17, detailed views are illustrated of the spigot 152. The spigot 152 is configured as a spigot assembly which includes at least a spigot body 330, a spigot gasket 332, and a spigot housing 334. In some aspects, the spigot body 330 includes a press button or tab 336 with a plurality of ridges 338 disposed therealong, a spout 342, and a spout bearing 344. The press tab 336 and the spout 342 are formed integrally with the spout bearing 344, and a first flow channel aperture 346 is defined through the spout 342 and the spout bearing 344. In some aspects, the first flow channel aperture 346 defined through the spout 342 is configured as an outlet for the spigot 152. In addition, the spout bearing 344 includes cylindrical fastening tabs 348 which extend outwardly from opposing sides of the spout bearing 344, and the spout bearing 344 includes a substantially curved rear surface 350. In some aspects, the spigot body 330 is formed as a unitary component from injection molded plastic, such as, e.g., polypropylene (“PP”), homopolymer PP, Copolymer PP, Random Copolymer, thermoplastics, and/or any other plastics or polyolefins, or combinations thereof.

In some aspects, the spigot gasket 332 defines a substantially curved outward face 352 which corresponds to the geometry of the curved rear surface 350 of the spout bearing 344. Further, the spigot gasket 332 defines a second flow channel aperture 354 which extends therethrough in a direction that is parallel with the z-axis 130 (see FIG. 1). The spigot gasket 332 further defines one or more recessed surfaces 356 in the outward face 352 thereof, which improves sealing of the second flow channel aperture 354 when the spigot 152 is assembled. In particular, the outward face 352 of the spigot gasket 332 engages with the curved rear surface 350 of the spout bearing 344, thus providing an air-tight and water-tight seal between the second flow channel aperture 354 and the environment. In some aspects, the spigot gasket 332 may be made of silicone or another rubber like material or elastomer, or the spigot gasket may be made of a combination of plastic and silicone.

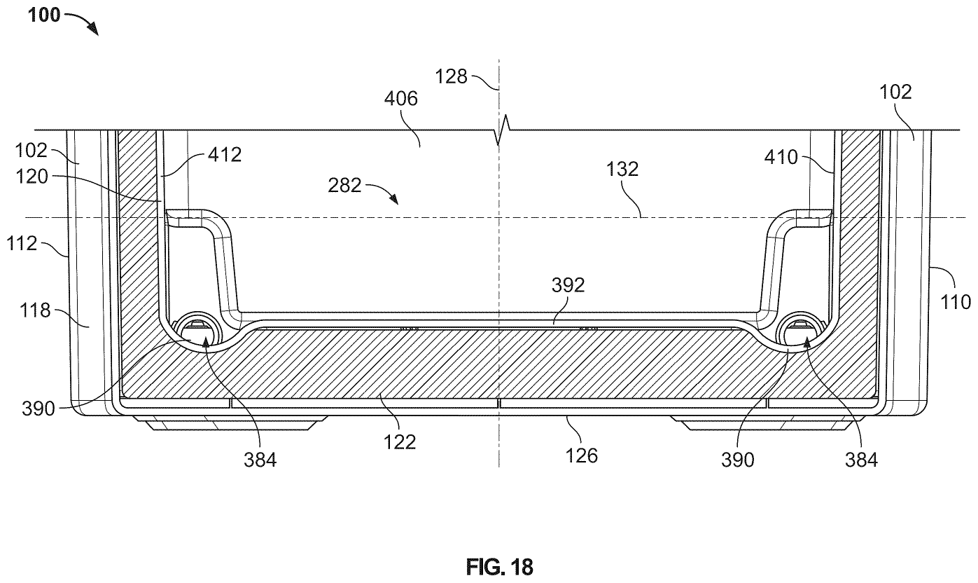

Still referring to FIGS. 15-17, the spigot housing 334 defines a spigot cavity 358 therein which is shaped to correspond to and receive the spigot body 330. Further, the spigot housing 334 defines a rear protrusion 360 extending rearwardly from the spigot cavity 358 and defining a third flow channel aperture 362 therethrough. In addition, the spigot housing 334 includes cylindrical fastening apertures 364 (see FIGS. 17 and 18) extending through opposing sidewalls thereof. When the spigot 152 is assembled, the spigot gasket 332 is received within the spigot cavity 358, such that the second flow channel aperture 354 and the third flow channel aperture 362 are aligned with one another. The spigot body 330 is then received within the spigot cavity such that the spigot gasket 332 is disposed between the curved rear surface 350 of the spigot body 330 and the rear protrusion 360 of the spigot housing 334. The spigot body 330 is secured within the spigot housing 334 by inserting the cylindrical fastening tabs 348 in the corresponding cylindrical fastening apertures 364 (see FIGS. 17 and 18) of the spigot housing 334. The spigot body 330 may be formed as a unitary component from injection molded plastic, such as, e.g., polypropylene (“PP”), homopolymer PP, Copolymer PP, Random Copolymer, thermoplastics, and/or any other plastics or polyolefins, or combinations thereof. In some aspects, the spigot housing 334 further includes a top hook portion 366 which extends upwardly and outwardly from the spigot cavity 358.

In some aspects, the spigot 152 includes additional elements, such as a spigot spring 368, a bumper 370, a locking bar 372, a spigot seal 374, one or more spigot screws 376, and one or more nuts 378. With continued reference to FIGS. 15-17, the spigot spring 368 is coupled to the spigot body 330 within the spigot housing 334 and is configured to urge the press tab 336 of the spigot body 330 outward, i.e., away from the front wall 106 of the base 102. Put another way, the spigot spring 368 urges the spigot 152 to rotate in a first direction towards a “spigot closed” position, as discussed in greater detail below. To ensure that the spigot spring 368 does not force the press tab 336 to over-rotate, the bumper 370 is coupled to an upper end of the press tab 336, and the bumper 370 is configured to serve as a contact point between an upper end of the spigot body 330 and the spigot housing 334.

In some aspects, the bumper 370 includes a stepped top surface 380 and one or more tapered legs 382 which are configured to be received through correspondingly shaped apertures in the top of the spigot body 330, thus coupling the bumper 370 and the spigot body 330. To further ensure that the spigot spring 368 does not force the press tab 336 to over-rotate, the locking bar 372 is placed in contact with the upper end of the press tab 336. Specifically, the locking bar 372 is coupled to the top hook portion 366 of the spigot housing 334 and extends downwardly towards the spigot body 330. In some aspects, the locking bar 372 is configured as a spring, as will be discussed below in greater detail. Further, the spigot seal 374 is disposed around the rear protrusion 360 of the spigot housing 334 and is configured to provide an air-tight and water-tight seal between the rear protrusion 360 and the base inner wall 120 when the spigot 152 is secured to the container 100.

As discussed above for FIG. 11, the base outer wall 118 and the base insulation layer 122 each define a spigot aperture 274 therethrough in which the spigot 152 are received. As illustrated in FIGS. 15-17, the base inner wall 120 includes a fourth flow channel aperture 384 which aligns with the spigot aperture 274 when the container 100 is assembled. The spigot 152 is attached to the container 100 by securing the spigot 152 to the base inner wall 120 within the spigot aperture 274, such that the fourth flow channel aperture 384 is aligned with the third flow channel aperture 362 of the spigot housing 334 and the second flow channel aperture 354 of the spigot gasket 332. Specifically, the spigot 152 is secured to the container 100 by inserting the one or more spigot screws 376 through screw apertures 386 formed in the base inner wall 120 and tightening the one or more spigot screws 376 using the one or more nuts 378 fastened within the base inner wall 120. As a result, the spigot 152 is easily secured to the container 100 after the base 102 is assembled. Correspondingly, it is contemplated that the spigot 152 may be easily exchanged, replaced, or transferred between different containers, e.g., the containers 100, 250, thus increasing the ease of manufacture and repair. This in turn may increase user satisfaction and decrease manufacturing cost since shared elements can be exchanged, replaced, or transferred between container assemblies.

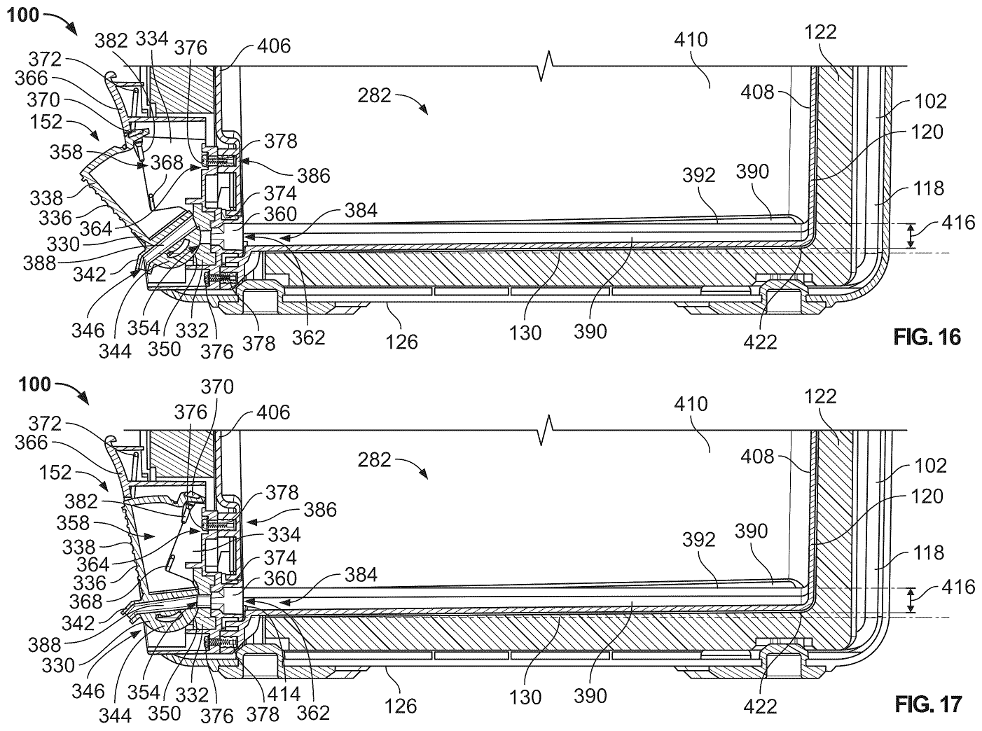

Referring specifically now to FIG. 16, a cross sectional view is illustrated of the container 100 taken along line 16-16 of FIG. 2 with the spigot 152 in a “spigot closed” position. As discussed above, the spigot 152 is configured to drain or dispense fluid contents stored within the internal volume 282 to the surrounding environment. Specifically, the spigot 152 is configured to be selectively opened to allow contents to pass through, and closed, to prevent contents from passing through. Opening the spigot 152 requires a user to apply a force, e.g., press, on the press tab 336 which causes the spigot body 330 to rotate about the spout bearing 344, or, more specifically, a center point 388 of the spout bearing 344 along which the cylindrical fastening tabs 348 (see FIG. 15) are aligned. In this way, the spigot 152 is rotated between the “spigot closed” position and a “spigot open position” (see FIG. 17). For example, the spigot 152 can passively exist in a “spigot closed” position in which the first flow channel aperture 346, i.e., the outlet, is not aligned with the second, third, and fourth flow apertures 354, 362, 384, meaning that the first flow channel aperture 346 is not in fluid communication with the internal volume 282. In the “spigot closed” position illustrated in FIG. 16, the bumper 370 serves as a contact point between an upper end of the spigot body 330 and the spigot housing 334, thus ensuring that the spigot spring 368 does not force the press tab 336 to over-rotate, as discussed above.

Referring now to FIG. 17, a cross sectional view is illustrated which is similar to that of FIG. 16 with the spigot 152 instead in the “spigot open” position. When force is applied to the press tab 336, the spigot body 330 rotates about the center point 388 of the spout bearing 344 until the first flow channel aperture 346, i.e., the output, is aligned with the second, third, and fourth flow apertures 354, 362, 384, thus permitting fluid to flow therethrough from the internal volume 282 to the surrounding environment. Put another way, pressing the press tab 336 causes the spigot to rotate in a second direction towards the “spigot open” that is opposite the first direction, such that the first flow channel aperture 346, i.e., the output, is in fluid communication with the internal volume 282. After the force being applied to the press tab 336 is released, the spigot spring 368 urges the spigot body 330 to rotate back to the “spigot closed” position.

However, a user may desire that the spigot 152 remain in a “spigot open” position without needing to manually force the press tab 336. Accordingly, the locking bar 372 is configured to optionally lock the spigot 152 in the “spigot open” position by engaging with the plurality of ridges 338 disposed on the press tab 336. Put another way, a user may lift the locking bar 372 over a front face of the press tab 336 and lock the locking bar 372 on a ridge of the plurality of ridges 338, and the locking bar 372 maintains contact with the plurality of ridges 338 since it is configured as a spring. In some aspects, the force provided by the locking bar 372 when engaged with the plurality of ridges 338 of the press tab 336 is greater than the force provided by the spigot spring 368. However, it is contemplated that the step of locking the spigot 152 in the “spigot open” position using the locking bar 372 is optional, and that the locking bar 372 may not provide a force that urges the spigot 152 to stay in the “spigot open” position in instances where the locking bar 372 is not lifted over a front face of the press tab 336. Thus, the spigot 152 as described herein includes enhanced functionality when draining fluid from the internal volume 282 of the container 100, including increased ease of use, comfort, and the ability to manually or passively drain the contents of the container 100.

Referring now to FIGS. 12 and 16-18, the container 100 further includes flow channels 390 formed in a bottom surface 392 of the base inner wall 120 that are each substantially curved channels and that are also fluidly connected with the spigots 152. Specifically, the flow channels 390 are aligned with the fourth flow channel apertures 384, which are further aligned with the first, second, and third flow channel apertures 346, 354, 362 defined within the spigot 152. As discussed above, the base inner wall 120 includes a plurality of walls or sides, such as a front side 406, a rear side 408, a left side 410, and a right side 412 which correspond to the front, rear, left, and right walls 106, 108, 110, 112 of the base 102. In some aspects, the flow channels 390 define bottommost points 414 of the internal volume 282, with respect to the y-axis 128. Each of the flow channels 390 define a channel height 416 that is measured in a direction that is parallel with the y-axis 128, a channel depth 418 that is measured in a direction that is parallel with the z-axis 130, and a channel width 420 that is measured in a direction that is parallel with the x-axis 132.

In some aspects, the channel height 416 is between about 1% and about 10% of the external height 154, or between about 1% and about 5% of the external height 154, or between about 1% and about 3% of the external height 154, or about 2.5% of the external height 154 of the container. In some aspects, the channel depth 418 is between about 50% and about 75% of the external depth 156, or between about 60% and about 70% of the external depth 156, or between about 60% and about 70% of the external depth 156, or about 67% of the external depth 156 of the container. In some aspects, the channel width 420 is between about 1% and about 20% of the external width 158, or between about 5% and about 15% of the external width 158, or between about 10% and about 15% of the external width 158, or about 12% of the external width 158 of the container.

Referring specifically to FIGS. 16 and 17, the flow channels 390 slope downwardly from the rear side 408 of the body inner wall 120 to the front side 406 of the body inner wall 120, such that the flow channels 390 have a maximum channel height 416 adjacent the front side 406. Specifically, the flow channels 390 are each formed on a downward vertical angle 422 which is offset relative to the z-axis 130, meaning that the flow channels 390 slope downward from the rear side 408 to the front side 406 of the base inner wall 120, and, as a result, the flow channels 390 define the channel height 416 that increases from a minimum adjacent the rear side 408 to the maximum adjacent the front side 406. In some aspects, the vertical angle 422 is between 0 degrees and about 5 degrees offset relative to the z-axis 130, or between about 0 degrees and about 1 degree offset relative to the z-axis 130, or between about 0.3 degrees and about 0.7 degrees offset relative to the z-axis 130, or about 0.5 degrees offset relative to the z-axis 130. Referring now to FIG. 12, the flow channels 390 are each wider at the rear side 408 of the body inner wall 120 than at the front side 406 of the body inner wall 120. Specifically, the flow channels 390 are each disposed at a horizontal angle 424 which is offset relative to the z-axis 130. In some aspects, the horizontal angle 424 is between about 0 degrees and about 5 degrees offset relative to the z-axis 130, or between about 0 degrees and about 1 degree offset relative to the z-axis 130, or between about 0.5 degrees and about 1 degree offset relative to the z-axis 130, or about 0.7 degrees offset relative to the z-axis 130.

Fluid is directed toward the spigots 152 along the body inner wall 120 by the sloped and widened configuration of the flow channels 390, which prevents fluid from becoming trapped in the container 100. As a result, the flow channels 390 and the placement of the spigots 152 on the container 100 cooperate to increase a dispensing efficiency value (DEV), which is a relationship between an initial amount of fluid (Fi) and a final amount of fluid (Ff) in the container, i.e., when a flow rate of fluid exiting the spigots 152 approaches zero ounces per second. The DEV can be calculated using the equation (1−Ff/Fi)*100. For example, if the container 100 is filled with 3.0 gallons of fluid, and 0.1 gallons of fluid remain trapped in the container 100, the DEV is 96.667%. By configuring the flow channels 390 to direct the fluid toward the spigots 152, the DEV can be increased, which means there will be less fluid trapped in the container 100 after dispensing. Additionally, the flow channels 390 and the spigots 152 cooperate to maintain a consistent flow rate through the spigots 152 even at low levels of fluid in the internal volume 282. Thus, an advantage of the present disclosure is that angled flow channels 390 are utilized to direct fluid to the spigots 152, thereby increasing the flow rate of fluid through the spigots 152 even when there are low levels of fluid in the internal volume 282 and even while the container 100 remains upright and level on all foot pads 208, e.g., without tipping the container 100 forward. As a result, it is possible to achieve more efficient and quicker fluid dispensing through the spigots 152 due to the angled flow channels 390.

Referring now to FIGS. 14, 16, and 17, the use of the valve 150 in combination with the spigots 152 further enhances the functionality of the container 100. In particular, rotating the valve 150 to the open position and while using the spigots 152, i.e., when the spigots 152 are in the “spigot open” position, reduces pressure build up in the container 100 during draining or emptying, which in turn provides a steady flow rate through the spigots 152 and prevents inefficient dispensing behavior, e.g., fluctuating flow rates, gurgling, and trapped fluid. As discussed above, rotating the valve 150 to the open position provides an air flow path, which allows the internal volume 282 to be in fluid communication with the ambient environment. When the spigots 152 are in the “spigot open” position. i.e., when contents within the internal volume 282 are being dispensed through the spigots 152, air from the ambient environment is drawn through the air flow path defined through the valve 150, thereby preventing a negative, suction pressure from forming in the internal volume 282 as a result of fluid exiting the internal volume 282. Accordingly, a steady, consistent flow through the spigots 152 is maintained by using the valve 150 in combination with the spigots 152, which further increases the amount of fluid that can be dispensed from the container 100, i.e., increases the DEV, and delays slow flow rates through the spigots 152. Additionally, the rounded bottom corners and edges at the second end 126 permit a user to tip or lean the container 100 forward to direct fluid toward the spigots 152, which also increases the DEV.

Although various aspects are herein disclosed in the context of certain preferred embodiments, implementations, and examples, it will be understood by those skilled in the art that the present invention extends beyond the specifically disclosed embodiments to other alternative embodiments and/or uses of the inventive aspects and obvious modifications and equivalents thereof. In addition, while a number of variations of the aspects have been noted, other modifications, which are within their scope, will be readily apparent to those of skill in the art based upon this disclosure. It should be also understood that the scope of this disclosure includes the various combinations or sub-combinations of the specific features and aspects of the embodiments disclosed herein, such that the various features, modes of implementation and operation, and aspects of the disclosed subject matter may be combined with or substituted for one another. Thus, it is intended that the scope of the present invention herein disclosed should not be limited by the particular disclosed embodiments or implementations described above, but should be determined only by a fair reading of the claims.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

We claim:

1. A container, comprising:
a base including an outer wall, an insulation layer, and an inner wall;
a lid movably coupled to the base at a first end thereof;
a plurality of spigots coupled to a front wall of the base at a second end thereof, the second end being opposite the first end, the front wall being opposite a rear wall, and the front wall being connected to the rear wall by a pair of side walls; and
a plurality of flow channels formed in the inner wall of the base,
wherein the plurality of spigots are fluidly coupled to the plurality of flow channels.

2. The container of claim 1, wherein each spigot includes:
a housing that is coupled to the inner wall of the base, the housing defining a cavity therein;
a spigot body secured within the cavity and including a spout, a spout bearing, and a press tab; and
a gasket coupled to the housing and the spigot body within the cavity.

3. The container of claim 1, wherein each spigot defines a flow channel aperture therethrough, and wherein the flow channel aperture is coupled to a channel in the plurality of flow channels.

4. The container of claim 2, wherein the spigot is configured to be rotated between a closed position and an open position.

5. The container of claim 4, wherein a spring is coupled to the spigot body within the cavity and is configured to rotate the spigot in a first direction towards the closed position, and wherein pressing the press tab rotates the spigot in a second direction toward the open position.

6. The container of claim 5, wherein a locking bar is coupled to the housing and is configured to selectively engage with the press tab to lock the spigot in the open position.

7. The container of claim 1, wherein the outer wall defines a y-axis that extends between the first end and the second end of the container, and wherein the container further includes a plurality of lid fasteners coupled to the lid.

8. The container of claim 7, wherein the plurality of spigots are horizontally aligned with the plurality of lid fasteners with respect to the y-axis.

9. A container, comprising:
a base including an outer wall, an insulation layer, and an inner wall;
a lid including a top portion, an insulation portion, and a bottom portion, the lid being coupled to the base at a first end thereof; and
a valve disposed within the lid, the valve being configured to be rotated between a first position and a second position, and the valve being spaced apart from a flow channel formed along the inner wall of the base at a second end that is opposite the first end;
wherein, when the valve is in the first position, an outlet of the valve is in communication with an internal volume of the container; and
wherein, when the valve is in the second position, the outlet of the valve is not in fluid communication with the internal volume of the container.

10. The container of claim 9, wherein the valve is received within a valve aperture that extends longitudinally through each of the top portion, the bottom portion, and the insulation portion of the lid.

11. The container of claim 9, wherein the valve includes a hollow valve body, legs extending downward from the hollow valve body, and a rectangular tab extending upward from the hollow valve body.

12. The container of claim 11, wherein an airflow path between the internal volume of the container and the outlet of the valve is defined through the hollow valve body when the valve is in the first position.

13. The container of claim 10, wherein the top portion of the lid defines a recessed portion that surrounds the valve aperture, the recessed portion including a first marker disposed thereon.

14. The container of claim 13, wherein the valve includes a second marker disposed thereon that indicates a rotational position of the valve relative to the first marker disposed on the recessed portion of the top portion of the lid.

15. The container of claim 9, wherein the flow channel includes a plurality of flow channels and the container includes a plurality of spigots fluidly coupled to the plurality of flow channels.

16. A container, comprising:
a base including an outer wall, an insulation layer, and an inner wall;
a lid coupled to the base at a first end thereof; and
a fill level component coupled to the outer wall;
a central aperture formed through the outer wall and the insulation layer; and
a central window disposed in the inner wall,
wherein the fill level component, the central aperture, and the central window are aligned with one another such that at least one of an internal volume of the container or contents therein is visible through the fill level component.

17. The container of claim 16, wherein the fill level component includes gradient lines disposed thereon corresponding to content levels of the internal volume of the container.

18. The container of claim 16, wherein the central window is integrally formed with the inner wall.

19. The container of claim 16, wherein the fill level component includes a plurality of fastening posts extending around a periphery thereof.

20. The container of claim 19, wherein the central aperture includes a plurality of fastening tabs around a periphery of the central aperture.

21. The container of claim 16, wherein the fill level component is translucent or transparent.

22. The container of claim 21, wherein the central window is translucent or transparent.
